(19) United States
(12) Patent Application Publication
(10) Pub. No.: US 2009/0001672 A1
(43) Pub. Date: Jan. 1, 2009

(54) Gasket

(75) Inventors: Kazuhiro Takahashi, Okayama (JP); Atsushi Sato, Okayama (JP)

Correspondence Address: BACON & THOMAS, PLLC, 625 SLATERS LANE, FOURTH FLOOR, ALEXANDRIA, VA, 22314-1176, US

(73) Assignee: Uchiyama Manufacturing Corp., Okayama (JP)

(21) Appl. No.: 12/076,138

(22) Filed: Mar. 14, 2008

(30) Foreign Application Priority Data
Mar. 14, 2007 (JP) 2007-65631

(51) Int. Cl. F02F 11/00

(52) U.S. Cl. 277/595

(57) ABSTRACT

A gasket interposed between facing surfaces of two members to be sealed for sealing a space between the surfaces, the gasket comprising a loop-like shape jointed gasket base plate formed by being jointed an inner periphery of one loop-like shape gasket member to an outer periphery of the other loop-like shape gasket member, the two loop-like shape gasket members having different spring constant respectively; and a bead portion formed along a circumferential direction of the loop-like shape jointed gasket base plate. The one of loop-like shape gasket members faces one surface of the two members and the other loop-like shape gasket member faces the other surface of the two members by the bead portion, when the gasket is disposed between the facing surfaces of the two members.

### FIELD OF THE INVENTION

The present invention relates to a gasket for sealing members to be sealed being interposed in a fastened and compressed manner between two facing surfaces of members to be sealed, for example, between a cylinder block and an oil pan of internal combustion engines, between a cylinder head and a cylinder block, or an actual equipment case and an oil pan of transmissions of automobiles.

### PRIOR ART

A gasket made of rubber or synthetic resin is generally interposed between the surfaces of the members to be sealed as mentioned above and is compressed by fastening with a bolt so as to achieve sealing of each surface to be sealed by its pressure.

The surfaces to be sealed between the cylinder block and the oil pan are generally heavily vibrated, so that the contained oil easily scatters or actively flows. The material of the gasket to be interposed therebetween is required to have a superior sealing ability capable of preventing oil leakage and percolation. The inner pressure in the space to be sealed between the cylinder block and the oil pan is remarkably high by the wave motion of oil, therefore it is highly required to further improve the sealing ability than usual. Therefore, the fastening force with bolts are increased in order to prevent the seal leakage and the contact pressure between the surfaces to be sealed is increased. When the fastening force with bolts has been increased where the base plate of gasket has the same spring constant (comprising one rigid material), however, there is a fear that deflection is caused between bolts to deteriorate the sealing ability if the fastening force is extremely increased because the oil pan made of sheet metal has an inferior strength than the cylinder block made of cast metal.

The following patent document 1 discloses a cylinder head gasket constructed such that a base plate having a bead portion in a form of a half bead and two members having different spring constant are overlapped and integrated in advance and the base plate and the two members having different spring constant constitute a bead portion.

Such a cylinder head gasket has a cylinder bore opening corresponding to a cylinder bore and a cooling medium flowing bore opening corresponding to a cooling medium flowing bore. The inner pressure of the cooling medium in the cooling medium flow bore is low comparing that the inner pressure of the combustion chamber is extremely high, so that it is desirable to seal them with a suitable contact pressure respectively. The document describes that when a suitable contact pressure is provided for the cylinder bore opening and the cooling medium flow bore opening respectively, a balanced sealing ability can be obtained.

### [Patent Document 1] JP-A-2005-320925

### SUMMARY OF THE INVENTION

### Problems to be Solved in the Invention

The cylinder head gasket of the patent document 1 is to keep a suitable sealing ability for each portion by varying the spring constant of the portion where a bead portion is formed depending on the difference of the inner pressure of the cylinder bore opening and the cooling medium flow bore opening. However, such a gasket does not aim to prevent the deflection between the bolts of the gasket interposed between the oil pan and the engine block. Further, the cylinder head gasket is constructed by laminating two members and has a fixed thickness according to such a structure. Therefore, such a gasket is not suitable for a gasket which requires slimness and is not easily processed because it requires to overlap and integrate two members with different spring constant with the base plate having a bead portion, so that improvement has been desired.

The present invention is proposed in order to solve the above-mentioned problems and its object is to provide a gasket which is interposed between the members to be sealed under a fastened and compressed manner, achieves good sealing ability without being affected by the inner pressure in the space to be sealed, and is easily manufactured.

### Means to Solve the Problem

According to the first aspect of the present invention, a gasket interposed between facing surfaces of two members to be sealed for sealing a space between the surfaces comprises a loop-like shape jointed gasket base plate formed by being jointed an inner periphery of one loop-like shape gasket member to an outer periphery of the other loop-like shape gasket member, the two loop-like shape gasket members having different spring constant respectively, and a bead portion formed along a circumferential direction of the loop-like shape jointed gasket base plate. The one of loop-like shape gasket members faces one surface of the two members and the other loop-like shape gasket member faces the other surface of the two members by the bead portion, when the gasket is disposed between the facing surfaces of the two members.

According to the second aspect of the present invention, the two loop-like shape gasket members are made of metal plate. According to the third aspect of the present invention, the two loop-like shape gasket members are made of different material having different spring constant respectively. Further according to the fourth aspect of the present invention, the two loop-like shape gaskets members have different spring constant because of their thickness.

According to the fifth aspect of the present invention, the bead portion is a half bead structure. According to the sixth aspect of the present invention, the bead portion has a joint portion formed by being jointed the inner periphery of the one loop-like shape gasket member and the outer periphery of the other loop-like shape gasket member, the two loop-like shape gasket members having different spring constant respectively, and the joint portion is formed at a position deviated from an intermediate portion of its width in its radial direction. According to the seventh aspect of the present invention, the bead portion is a full bead structure. Further according to the eighth aspect of the present invention, the bead portion has a plurality of joint portions formed by being jointed the inner periphery of the one loop-like shape gasket member and the outer periphery of the other loop-like shape gasket member. According to the ninth aspect of the present invention,

the loop-like shape jointed gasket base plate is covered with a coating layer made of rubber or synthetic resin on at least its one surface.

According to the tenth aspect of the present invention, the loop-like shape jointed gasket base plate is composed of two gasket members with different spring constant respectively in which each of the two gasket members is formed itself into a loop-like shape by being punched out from a plate material so as to conform the inner periphery of the one loop-like shape gasket member to the outer periphery of the other loop-like shape gasket member in their size, and combined with each other by being jointed the inner periphery of the one loop-like shape gasket member to the outer periphery of the other loop-like shape gasket member, and the bead portion is formed by being fabricated the loop-like shape jointed gasket base plate.

### Effect of the Invention

According to the above-mentioned gasket interposed between facing surfaces of two members to be sealed for sealing a space between the surfaces, the gasket comprises a loop-like shape jointed gasket base plate formed by being jointed an inner periphery of one loop-like shape gasket member to an outer periphery of the other loop-like shape gasket member, the two loop-like shape gasket members having different spring constant respectively, and a bead portion formed along a circumferential direction of the loop-like shape jointed gasket base plate, wherein the one of loop-like shape gasket members faces one surface of the two members and the other loop-like shape gasket member faces the other surface of the two members by the bead portion, when the gasket is disposed between the facing surfaces of the two members. Therefore, such sealing ability that the stress distribution of compressed fastening is low and stable is obtained. Namely, when the contact pressures between the surfaces to be sealed have difference because of the rigidity of the loop-like shape gasket base plate comprised of two loop-like shape gasket members and the strength of two members to be sealed is different, if a loop-like shape gasket member with a low spring constant is provided for the member to be sealed with small strength, there causes no deformation of the members to be sealed even when a fixed fastening force is given, thereby enabling to keep good sealing ability. Accordingly, the sealing ability of the gasket can be improved without requiring the fastening force with bolts to be strong more than necessary. Further, the gasket has a bead portion and a high sealing ability is obtained by utilizing its restoring reaction force.

As the result, such a gasket is suitable to be interposed between the members to be sealed which have extremely high inner pressure between the space to be sealed.

According to the gasket of the second aspect of the present invention, the loop-like shape gasket member is made of metal plate, so that it can achieve the characteristic of a metal sheet gasket, two loop-like shape gasket members with different spring constant can be easily obtained, and bead processing and punch molding are facilitated.

According to the third and fourth aspects of the present invention, the spring constant can be easily set, so that a suitable combination of the spring constant can be set depending on the portion to which the gasket is interposed, thereby achieving low cost.

According to the fifth and the seventh aspects of the present invention, the bead portion is a half bead structure or a full bead structure, so that a suitable structure can be provided according to the portion to which the gasket is interposed.

According to the sixth aspect of the present invention, the spring constant can be minutely adjusted in a fastening direction of each member by forming the joint portion of the bead portion at a position deviated toward its radial direction in its width direction and more suitable combination of the spring constant can be achieved. In addition, a gasket with good sealing ability can be obtained depending on the portion to be interposed.

According to the eighth aspect of the present invention, the bead portion has a plurality of joint portions, so that most suitable combination of the spring constant can be easily executed depending on the portion to which the gasket is interposed, thereby achieving low cost.

According to the ninth aspect of the present invention, a coating layer made of rubber or synthetic resin is provided at least on one face of the loop-like shape gasket base plate. The coating layer directly contacts the faces to be sealed, so that a preferable sealing ability can be obtained. In addition, when the thickness of two loop-like shape gasket members are different, if the thickness of the coating layer is differed accordingly, the surface of the gasket has a uniform thickness in addition to the most suitable combination of the spring constant considering the sealing ability, thereby further improving the sealing ability.

According to the above-mentioned gasket, the loop-like shape jointed gasket base plate is composed of two gasket members with different spring constant respectively in which each of the two gasket members is formed itself into a loop-like shape by being punched out from a plate material so as to conform the inner periphery of the one loop-like shape gasket member to the outer periphery of the the other loop-like shape gasket member in their size, and combined with each other by being jointed the inner periphery of the one loop-like shape gasket member to the outer periphery of the the other loop-like shape gasket member, and the bead portion is formed by being fabricated the loop-like shape jointed gasket base plate. As a result, the gasket having the above-mentioned effects can be easily manufactured.

### BRIEF DESCRIPTION OF THE DRAWINGS

FIG. 1 is a partially broken front view diagrammatically showing a part of automobile engine using the gasket of the present invention.

FIG. 2 is an enlarged view of “X” in FIG. 1.

FIG. 3 is a sectional view showing modified embodiment of the gasket of the present invention.

FIG. 4 is a sectional view showing a modified embodiment of the gasket of the present invention.

FIG. 5 is a sectional view showing a modified embodiment of the gasket of the present invention.

FIG. 6 is a sectional view showing a modified embodiment of the gasket of the present invention.

FIG. 7 is a sectional view showing a modified embodiment of the gasket of the present invention.

FIG. 8 is a sectional view showing a modified embodiment of the gasket of the present invention.

FIG. 9 a sectional view showing a modified embodiment of the gasket of the present invention.

FIG. 10 a sectional view showing a modified embodiment of the gasket of the present invention.

FIG. 11 is a flow chart showing one example of the production process of the gasket of the present invention.

FIG. 12a to FIG. 12c show one example of production process of the gasket of the present invention.

FIG. 13a to FIG. 13c show other example of production process of the gasket of the present invention.

FIG. 14 is a plan view showing other embodiment of the gasket of the present invention.

FIG. 15 is a fragmentary sectional view along the line Y-Y in FIG. 14.

### DETAILED DESCRIPTION OF THE INVENTION

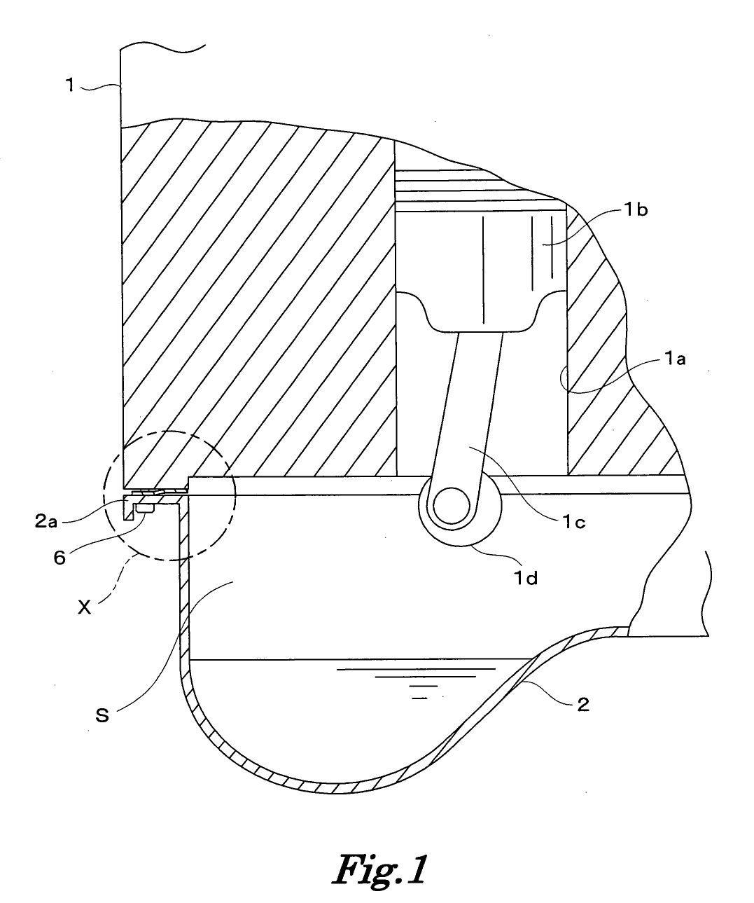

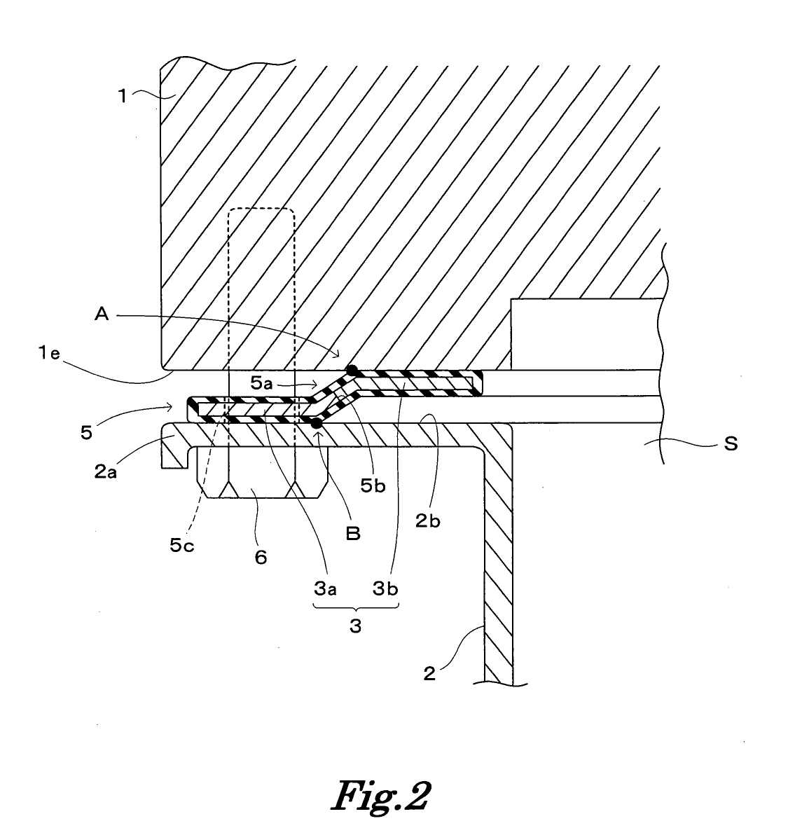

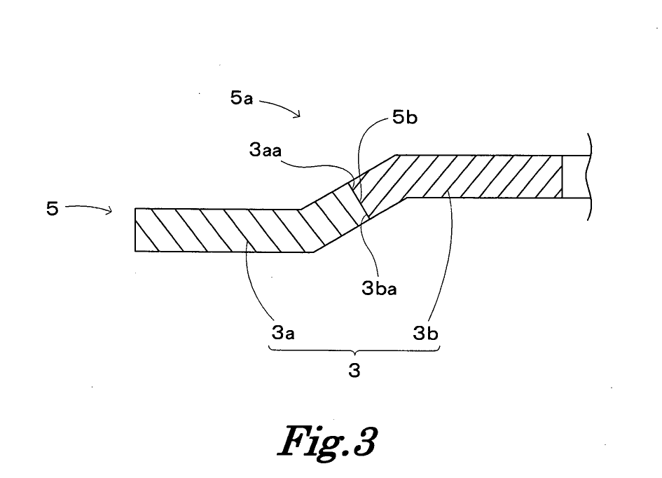

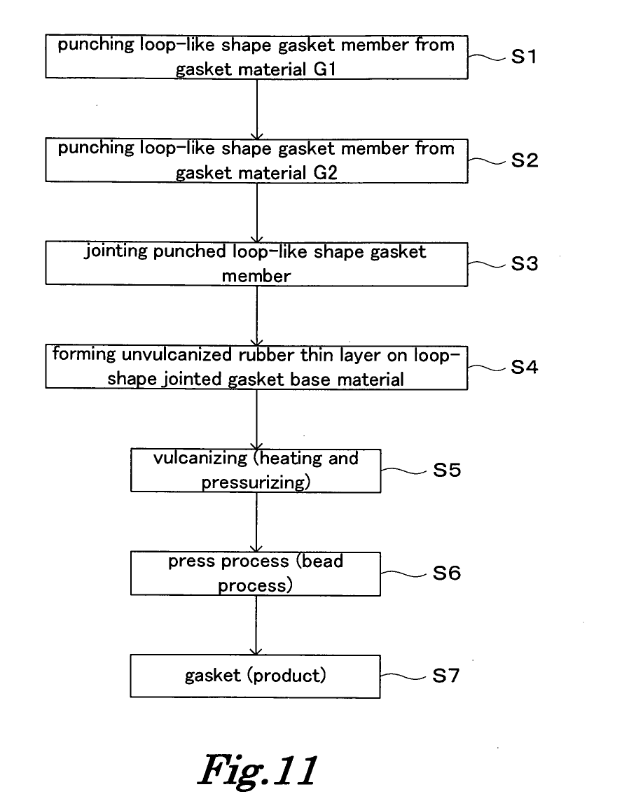

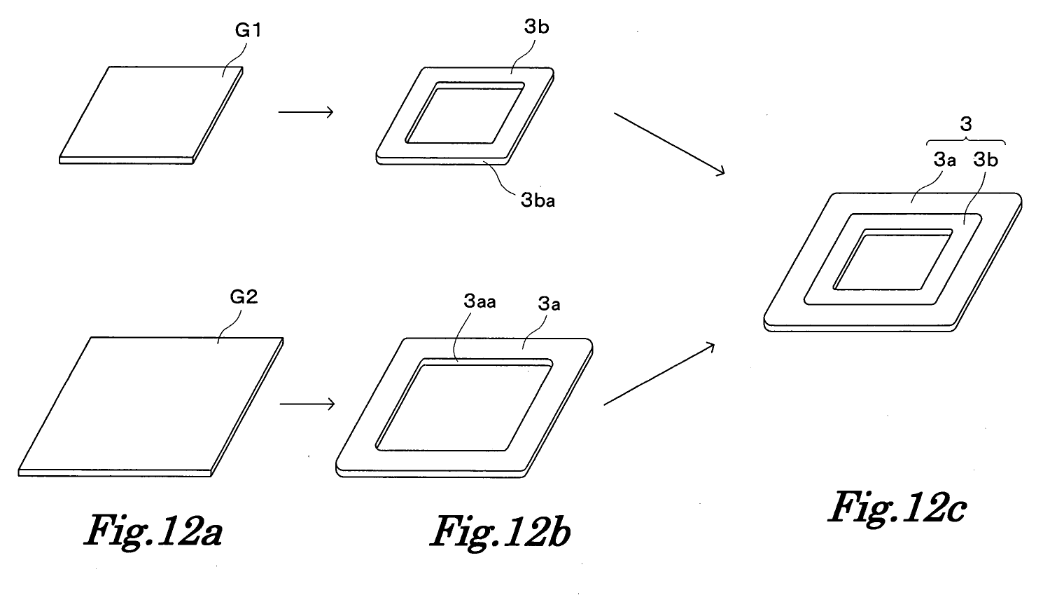

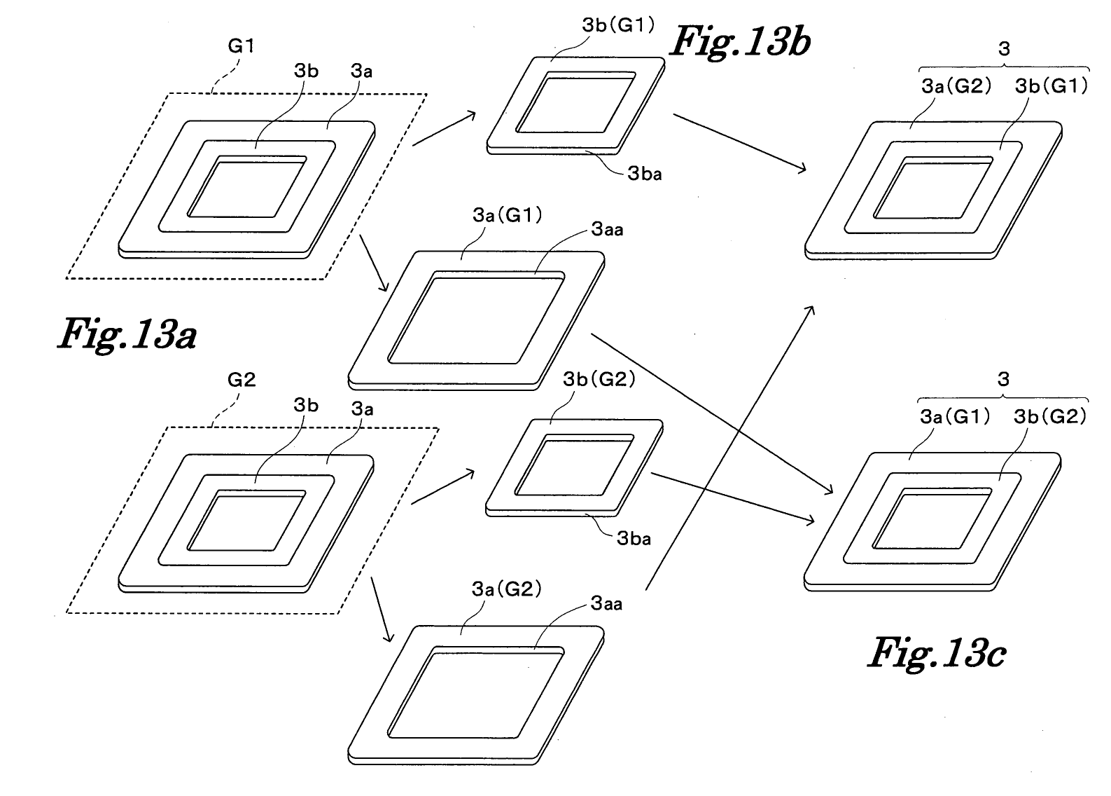

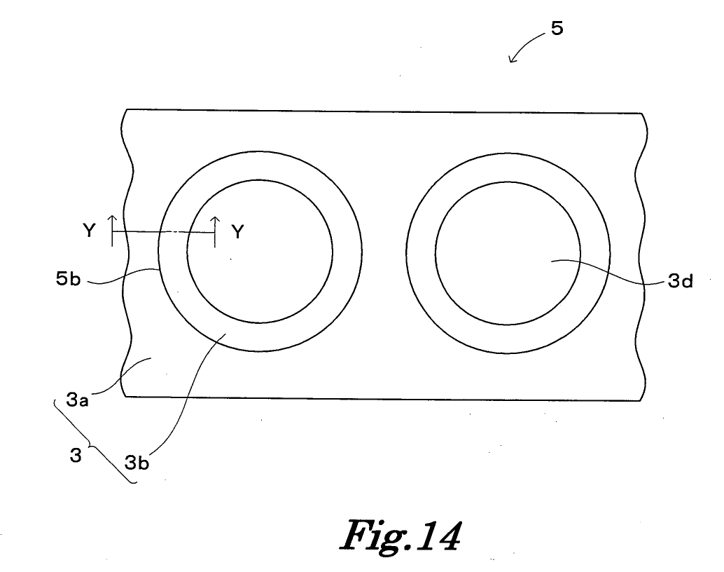

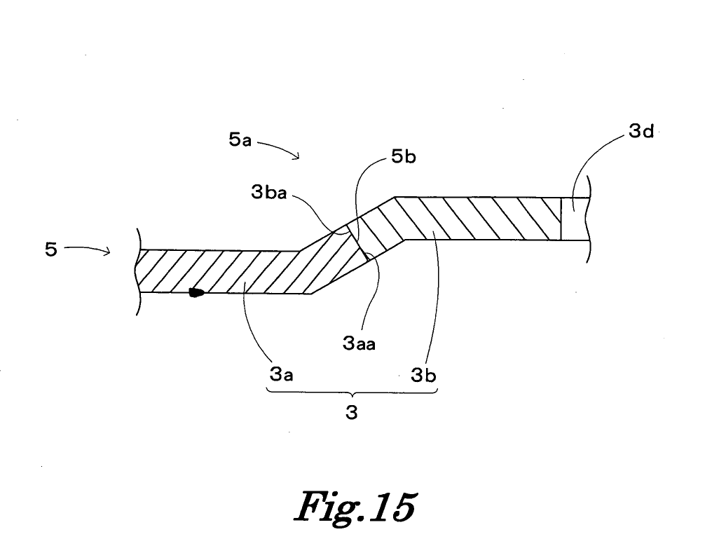

FIG. 1 is a partially broken front view diagrammatically showing a part of automobile engine using the gasket of the present invention, FIG. 2 is an enlarged view of “X” in FIG. 1, FIG. 3 to FIG. 10 show a sectional view showing modified embodiments of the gasket of the present invention, FIG. 11 is a flow chart showing one example of the production process of the gasket of the present invention, FIG. 12a to FIG. 12c show one example of production process of the gasket of the present invention, FIG. 13a to FIG. 13c show other example of production process of the gasket of the present invention, FIG. 14 is a plan view showing other embodiment of the gasket of the present invention, and FIG. 15 is a fragmentary sectional view along the line Y-Y in FIG. 14. In the following preferred embodiment 1, the gasket of the present invention is interposed between the contacting faces of the cylinder block and the oil pan of the vehicle engines and the preferred embodiment 2 shows an example wherein the gasket is interposed between the contacting faces of the cylinder block and the cylinder head. However, the present invention is not limited to such embodiments, and the gasket of the present invention can be interposed between the contacting faces of the cylinder head and the head cover, those between the actual equipment case and the oil pan of the transmissions of the automobiles, and those requiring highly accurate sealing of other industrial equipment.

FIG. 1 shows an automobile engine wherein a cylinder head and a head cover (both are not shown) are connected on a cylinder block (member to be sealed) 1 and an oil pan (member to be sealed) 2 is connected under the cylinder block 1. The cylinder block 1 is constructed with a molded body made of cast and has a main mechanism of the engine such as a cylinder 1a, a piston 1b moving up and down in the cylinder 1a, a con rod 1c connected with the piston 1b, a crank shaft id connected at the lower end of the con rod 1c and so on. The connecting portion of the con rod 1c and the crank shaft 1d and the crank shaft 1d are positioned in a space above the oil pan 2. The lower end of the periphery of the cylinder block 1 is polish processed to form a connecting face (face to be sealed) 1e with the oil pan 2. Other mechanism of the engine is not shown and its explanation is omitted here.

The oil pan 2 is formed like a vessel with its upper end opened by metal processing an iron plate or a steel plate and stores a lubricant oil (engine oil) for refluxing and lubricating in the mechanical section of the engine. An outward flange portion 2a is formed at the periphery side of the upper opening and the upper face of the flange portion 2a is formed as a contacting face (face to be sealed) 2b with the cylinder block 1. The gasket 5 of the present invention is interposed between each contacting face 1e, 2b of the cylinder block 1 and the oil pan 2 and they are connected to be integrated by screwing with the bolt 6 while compressing the gasket 5. The reference numeral S indicates a space to be sealed.

The gasket 5 comprises a loop-like shape jointed gasket base plate 3 and a bead portion 5a formed along the circumferential direction of the gasket base plate 3 (see FIG. 3). The gasket base plate 3 is formed by jointing an outer periphery 3ba of a loop-like shape gasket member 3b provided at an inner periphery side (hereinafter called as a loop-like shape gasket member 3b at the inner periphery side) of two loop-like shape gasket members 3a, 3b with different spring constant and an inner periphery 3aa of the loop-like shape gasket member 3a provided at the outer periphery side (hereinafter called as the loop-like shape gasket member 3a at the outer periphery side). Refer to FIG. 3. Therefore, the outer periphery 3ba of the loop-like shape gasket member 3b at the inner periphery side and the inner periphery 3aa of the loop-like shape gasket member 3a at the outer periphery side become the same size.

The gasket 5 is provided with the bead portion 5a, so when it is interposed between the cylinder block 1 and the oil pan 2, one of two loop-like shape gasket members with different spring constant, namely the loop-like shape gasket member 3b at the inner periphery side is designed to face the contacting face le of the cylinder block 1, on the other hand the other loop-like shape gasket member, namely the loop-like shape gasket member 3a at the outer periphery side is designed to face the contacting face 2b, thereby being fastened with the bolt 6 in a compressed condition. A coating layer 4 made of rubber or synthetic resin is formed on both faces of the loop-like shape jointed gasket base plate 3. The coating layer 4 is not necessarily formed on both faces, and may be formed only on one face, and further, it may not be provided because application of the coating layer 4 is selected depending on the interposing portion. The reference numeral 5b shows a jointing portion of the two loop-like shape gasket members 3a, 3b and is formed by a laser welding, a spot welding, caulking or adhesion.

Two loop-like shape gasket members 3a, 3b are made of a rolled steel sheet (SUS, SPPC) or a synthetic resin sheet. Further, they are made of different material and their difference of spring constant may be caused by the difference of the material (hard or soft). For example, the loop-like shape gasket members 3a, 3b made of SUS304 and SUS430 respectively may be connected to form a gasket 5 made of different materials. In such a case, the spring constant is easily set and a suitable combination of spring constant may be achieved depending on the portion to which the gasket 5 is interposed, thereby realizing low cost.

The rubber material constituting the coating layer 4 may include NBR, styrene-butadiene rubber (SBR); isoprene rubber (IR); chloroprene rubber (CR); butadiene rubber (BR); isobutylene-isoprene rubber (IIR); ethylene propylene rubber (EPM); fluoro rubber (FKM); silicone rubber (VMQ); chlorosulfonated polyethylene (CSM); ethylene-vinylacetate copolymer (EVA); chlorinated polyethylene (CPE); chloro-isobutene-isoprene rubber (CIR); epichlorohydrin rubber (ECO); nitrile isoprene rubber (NIR); natural rubber (NR); or the like.

The synthetic resin for the coating layer 4 and the loop-like shape gasket members 3a, 3b may be phenolic resin, urea resin, melamine formaldehyde resin, epoxy resin, alkyd resin, unsaturated polyester resin, diallyl phthalate resin, silicon resin or the like. Further, a mixture of the above-mentioned rubber material and these resin materials may be used.

The coating layer 4 may be formed such that a fiber materials is mixed with a rubber material or a synthetic resin material. The fiber materials to be mixed are a compressible inorganic fiber or a compressible organic fiber. For example, the compressible inorganic fiber other than asbestos may be glass fiber; ceramic fiber; rock wool; mineral wool; fused quartz fiber; chemical processed high silica fiber; fused alumina silicate fiber; alumina continuous fiber; stabilized zirconia fiber; boron nitride fiber; alkali titanate fiber; whiskers; boron fiber; carbon fiber; metal fiber; or the like. The organic fiber may be aromatic polyamide fibers; other polyamide fibers; polyolefine fibers; polyester fibers; polyacrylonitrile fibers; polyvinyl alcohol fibers; polyvinylchloride fibers; polyurea fibers; polyurethane fibers; polyfluorocarbon fibers; phenol fibers; cellulosic fibers; or the like.

The contact pressure of either face is increased in case of fastening and compressing by differing the spring constant of the loop-like shape gasket members 3a, 3b and the bead portion 5a is compressed by screwing with the bolt 6 to be elastically deformed, thereby improving the sealing ability of the gasket 5 by the multiplied restoring elasticity. When the bead portion 5a is formed in such a manner that the loop-like shape gasket member 3b at the inner periphery side faces the contacting face 1e of the cylinder block 1, a bolt hole 5c is formed on the loop-like shape gasket member 3a at the outer periphery side, and the bolt 6 is penetrated from the oil pan 2 to the cylinder block 1 to be fastened as shown in FIG. 2, it is preferable that the spring constant of the loop-like shape gasket member 3b at the inner periphery side which faces the contacting face 1e of the cylinder block 1 is increased and the spring constant of the loop-like shape gasket 3a at the outer periphery side which faces the contacting face 2b of the oil pan 2 is decreased. Thus, the contacting pressure of the loop-like shape gasket member 3b at the inner periphery side having higher spring constant is increased by fastening and compressing with the bolt 6, there is no fear that the bolt 6 is strongly fastened more than necessary by the difference with the contacting pressure applied to the loop-like shape gasket member 3a at the outer periphery side and further there is no fear that the flange portion 2a of the oil pan 2 is deflected and deformed between the bolts 6, 6, thereby obtaining a preferable sealing ability by the face contact thereof.

Namely, the gasket 5 is interposed between the contacting faces 1e, 2b of the cylinder block 1 and the oil pan 2 respectively, the loop-like shape gasket member 3b at the inner periphery side contacts with the contacting face 1e under pressure upon being screwed with the bolt 6, the pressurized contacting force is applied on the point A and the point B in FIG. 2, then the bead portion 5a is elastically deformed by compression to be made substantially flat. The pressurized contacting force applied to the point A becomes larger than that to the point B, so that the contact pressure of the loop-like shape gasket member 3b at the inner periphery side which faces the contacting face 1e can be higher. In addition to the restoring elasticity of the loop-like shape jointed gasket base plate 3 by the fastening and compression, a suitable sealing ability can be obtained. Therefore, such a gasket 5 is preferable to be interposed between the contacting faces 1e, 2b having extremely high inner pressure in the space S to be sealed. Even if there are deterioration of the axial force of the bolt 6 with age and any variation of pressurized contacting force in an areal direction of the contacting faces 1e, 2b, they can be compensated and the sealing ability can be kept uniformly and stably.

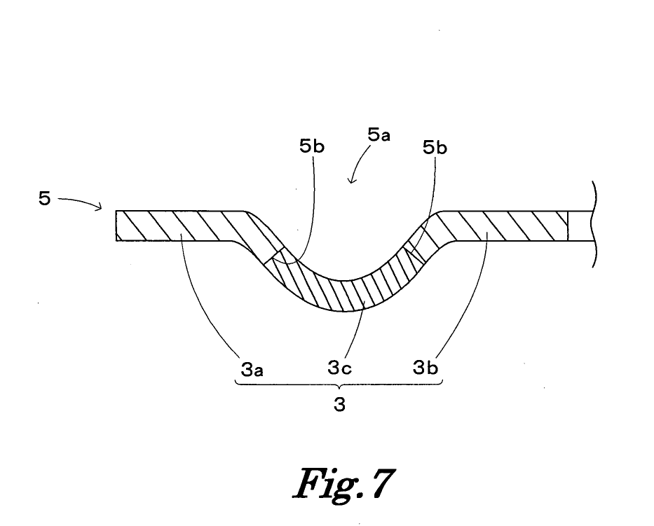

FIG. 3 to FIG. 10 show sectional views of other examples of the gasket of the present invention, the above-mentioned FIG. 2 and FIG. 3 to FIG. 6 show the gasket has a half bead structure and FIG. 7 to FIG. 10 show the gasket with a full bead structure. The gasket in the drawings is interposed between the cylinder block and the oil pan in such a manner that the cylinder block is provided at the upper part of the drawing and the oil pan is provided at the lower part thereof. The reference numerals same as the above mentioned embodiment have the same reference numerals and their explanations are omitted.

The gasket 5 in FIG .3 is different from the gasket 5 in FIG. 2 in that the coating layer 4 made of rubber or synthetic resin is not formed on both faces of the loop-like shape jointed gasket base plate 3 and they are same in that the loop-like shape gasket members 3a, 3b are made of different materials and the difference of the spring constant is made by the difference of the material, as mentioned above.

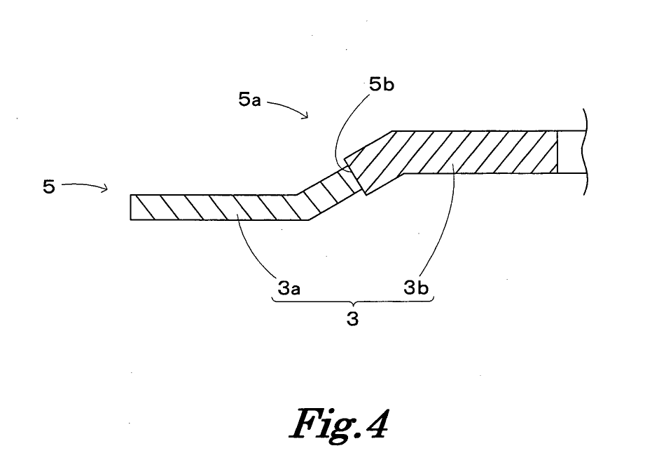

FIG. 4 shows a gasket 5 of which two loop-like shape gasket members 3a, 3b have different thickness and the difference of the spring constant is caused by the difference of thickness. If the same material is used, the spring constant can be varied by differing the thickness thereof and the setting of the spring constant may be easily executed. Therefore, a suitable combination of the spring constant can be easily done depending on the portion to be interposed by the gasket 5, thereby achieving a low cost.

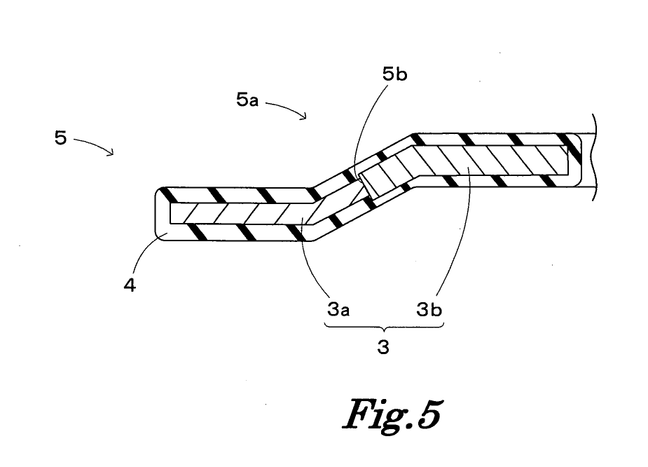

FIG. 5 shows the coating layer 4 is formed on both faces of the loop-like shape jointed gasket base plate 3 of FIG. 4. When the loop-like shape gasket members 3a, 3b with different thickness are used, the gasket 5 with a flat surface can be obtained by forming the coating layer 4.

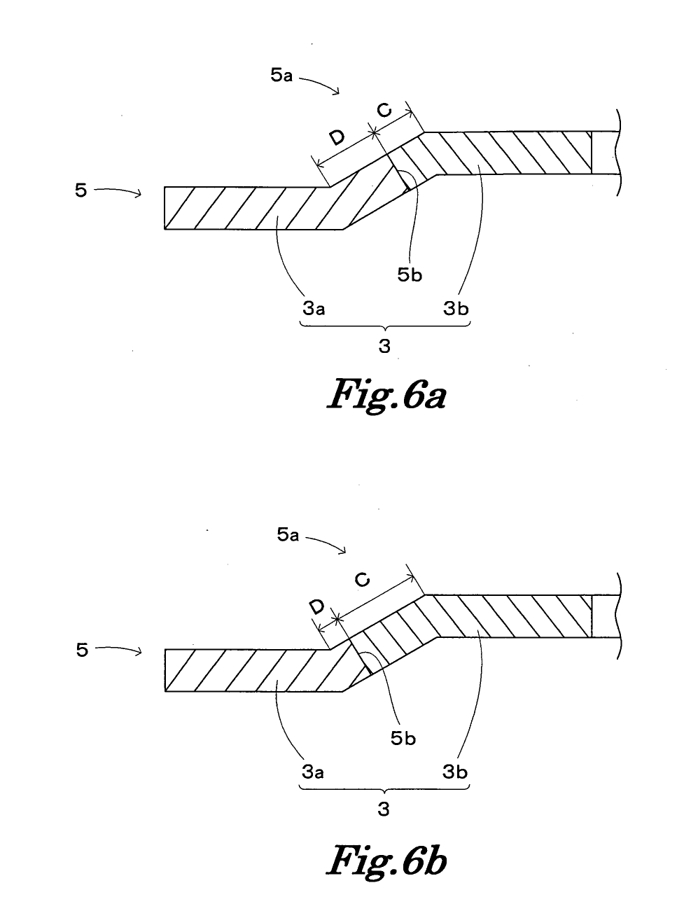

FIG. 6a and FIG. 6b show the gasket 5 of which joint portion 5b is out of the center of the width of the bead portion 5a to either side in the radial direction.

FIG . 6a shows the joint portion 5b which is deviated to the direction of the loop-like shape gasket 3b at the inner periphery side and the length relation in the figure is C<D.

FIG. 6b shows the joint portion 5b which is deviated to the direction of the loop-like shape gasket 3a at the outer periphery side and the length relation in the figure is C>D.

The spring constant can be minutely adjusted to fasten each member by making the joint portion 5b out of the width center of the bead portion 5a to either side in the radial direction, thereby achieving more suitable combination of the spring constant depending on the portion to be interposed.

The gasket 5 in FIG. 5 has a bead portion 5a constructed with full bead structure having a chevron section and includes two joint portions 5b. The number of the joint portion 5b is not limited to two and can be varied depending on the portion to be interposed with the gasket.

The reference numeral 3c shows a loop-like shape gasket member (hereinafter called at a middle loop-like shape gasket member 3c) provided between the middle of the loop-like shape gasket member 3a at the outer periphery side and the loop-like shape gasket member 3b at the inner periphery side. The peak of the chevron shaped bead portion 5a is designed to face the contacting face 2b of the oil pan 2. The material of the middle loop-like shape gasket member 3c preferably has a smaller spring constant than that of the loop-like shape gasket members 3a, 3b. In such a case, the contact pressure of the loop-like shape gasket members 3a, 3b having larger spring constant than that of the middle loop-like shape gasket member 3c is increased, in addition the bead portion 5a is elastically deformed by being compressed by fastening with the bolt 6, and the gasket 5 having superior sealing ability can be obtained because of the restoring elasticity.

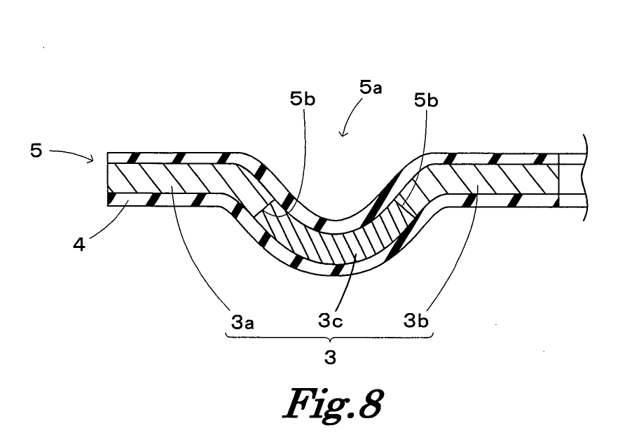

The gasket 5 in FIG. 8 is different from the gasket 5 in FIG. 7 in that the coating layer 4 made of rubber or synthetic resin is formed on both faces of the loop-like shape jointed gasket base plate 3 and they are same in that the difference of the spring constant of the middle loop-like shape gasket member 3c and those of the loop-like shape gasket members 3a, 3b is made by the difference of the material.

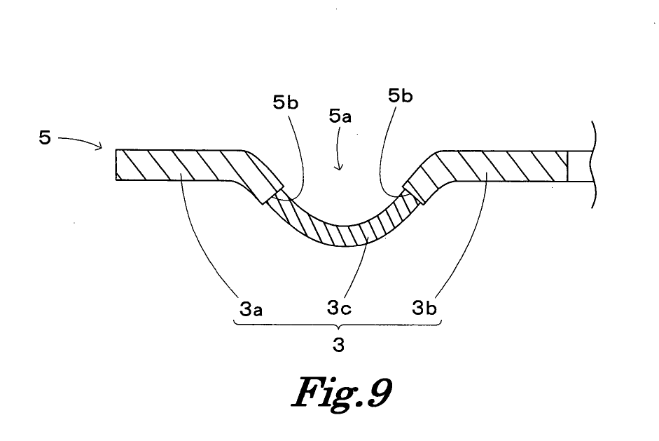

The gasket 5 in FIG. 9 includes the middle loop-like shape gasket member 3c having different thickness from those of the loop-like shape gasket members 3a, 3b and the difference of the spring constant is caused from the difference of the thickness.

Even when the same material is used, if the thickness is varied, the spring constant can be differed, so that the spring constant can be easily set. Therefore, a suitable combination of spring constant can be easily set to achieve a low cost.

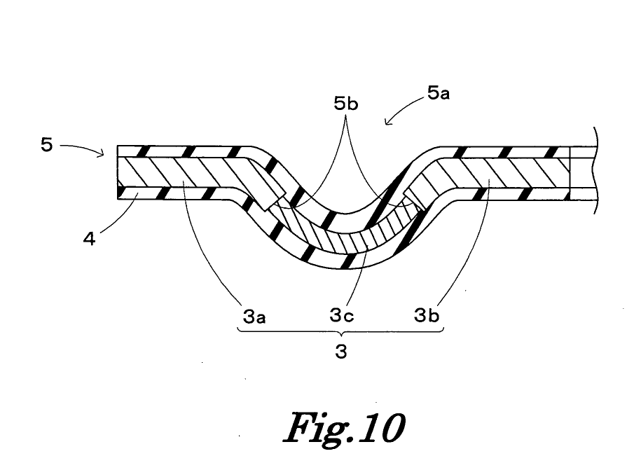

FIG. 10 shows a gasket in which the coating layer 4 is formed on both sides of the loop-like shape jointed gasket base plate 3 of FIG. 9. When the loop-like shape gasket members 3a, 3b, 2c have different thickness, a gasket 5 with flat surface can be obtained by providing the coating layer 4.

The production method of the gasket 5 of the present invention is explained referring to FIG. 11 to FIG. 13. Here, a production method of the gasket 5 formed with the coating layer 4 as shown in FIG. 2 is explained.

As shown in FIG. 11 and FIG. 12a-FIG. 12c, gasket materials G1, G2 made of two kinds of steel plate (metal sheet) with different spring constant are prepared (FIG. 12a), and loop-like shape gasket members 3b, 3a having magnitude correlation are obtained by punching in which the inner periphery 3aa of one gasket material G2 is same as the outer periphery 3ba of the other gasket material G1 (step S1, S2). The punched out loop-like shape gasket members 3b, 3a having different spring constant are temporarily assembled and the inner periphery 3aa and the outer periphery 3ba are welded by laser (step S3) and the loop-like shape jointed gasket base plate 3 as shown in FIG. 12c is obtained.

Next, an unvulcanized rubber is coated on the loop-like shape jointed gasket base plate 3 to form a thin layer (step S4), the produced layer is vulcanize-molded (step S5), and is press-processed, thereby forming the bead portion 5a with a half bead structure as shown in FIG. 2 (step S6). As a result, the gasket 5 comprised of the two loop-shape like gasket members 3a, 3b having different spring constant can be obtained (step S7).

If the gasket 5 does not have the coating layer 4, the steps S4-S5 are omitted. If the gasket 5 is to have the bead portion 5a of full bead structure, the bead portion 5a of full bead structure is formed in the press work in the step S6, thereby obtaining the gasket 5 shown in FIG. 7.

Accordingly, the gasket 5 having the above-mentioned effects can be easily produced and the loop-like shape jointed gasket base plate 3 can be effectively produced.

The production method of the gasket is not limited to the above-mentioned one and the gasket can be produced according to the method shown in FIG. 13a to FIG. 13c. In this case, two kinds of gasket materials G1, G2 with different spring constant are prepared (FIG. 13a), and loop-like shape gasket members 3b, 3a having magnitude correlation are obtained by punching the gasket materials G1, G2 respectively, in which the inner periphery 3aa of one of the gasket materials G1, G2 is same as the outer periphery 3ba of the other one of the gasket materials G1, G2. The punched out loop-like shape gasket members 3b, 3a having different spring constant are temporarily assembled and the inner periphery 3aa and the outer periphery 3ba are welded by laser and a plurality of loop-like shape jointed gasket base plates 3 comprised of two loop-like shape gasket members 3b, 3a with different spring constant as shown in FIG. 13c are obtained. The steps S4 to S7 shown in FIG. 11 and a bead processing are the same as the embodiment mentioned above, so their explanations are omitted here.

According to this method, the gasket 5 having the above-mentioned effects can be easily produced and the loop-like shape jointed gasket base plate 3 can be effectively produced. In addition, the gasket materials G1 and G2 can be used without waste, thereby reducing cost.

### EMBODIMENT 2

The above embodiment 1 uses a gasket 5 comprised of a substantially rectangular loop-like shape jointed gasket base plate 3 which is interposed between the contacting faces 1e, 2b of the cylinder block 1 and the oil pan 2. In this embodiment 2, the gasket 5 is interposed between a cylinder block (not shown) and a cylinder head (not shown).

FIG. 14 and FIG. 15 show a gasket of embodiment 2. The common portions with the above embodiment have the same reference numerals and their explanations are omitted here. The reference numeral 3d shows a cylinder bore opening and a cooling medium flow bore opening for passing through a cooling medium is not shown.

Such a gasket 5 (cylinder head gasket) is interposed between the contacting faces of the cylinder block and the cylinder head with a bolt (not shown) under fastened and compressed condition and a multi-cylinder engine is assembled. The cylinder bore at the cylinder block side and the combustion chamber at the cylinder head side are communicated via the cylinder bore opening 3d.

This embodiment is different from the above-mentioned embodiment 1 in that the loop-like shape gasket member 3b at the inner periphery side is formed circular. However, they are common that the inner periphery 3aa and the outer periphery 3ba of two loop-like shape gasket members 3b, 3a having different spring constant are connected to form a loop-like shape jointed gasket base plate 3 and the bead portion 5a is formed along the circumferential direction of the gasket base plate 3 (see FIG. 15).

The loop-like shape gasket member 3b at the inner periphery side is made of a material with a high spring constant (high rigidity) because the inner pressure of the cylinder bore opening 3d is increased because the opening 3d communicates with the combustion chamber, on the other hand the loop-like shape gasket member 3a at the outer periphery side is made of a material having a lower spring constant than the loop-like shape gasket member 3b at the inner periphery side. Accordingly, the contact pressure of the cylinder bore opening 3d side can be made high, thereby achieving a high sealing ability. Although it is not shown in the figure, the loop-like shape gasket member 3a having a small spring constant is provided around the cooling medium flow bore opening which is arranged around the cylinder bore opening 3d, so that the sealing around the bore having a small inner pressure can have suitability.

It is the same as the above-mentioned embodiment in that the difference of the spring constant can be made by the difference of the material. For example, the loop-like shape gasket 3b at the inner periphery side is made of SUS and the loop-like shape gasket member 3a at the outer periphery side is made of SECC, the spring constant at the cylinder bore opening 3c side can be set larger. The constitution of the spring constant is not limited to the above, and it goes without saying that the spring constant of the loop-like shape gasket member 3a at the outer periphery side can be larger than that of the loop-like shape gasket member 3b at the inner periphery side.

As mentioned above, one of the two loop-like shape gasket members 3a, 3b having different spring constant is designed to face one of the contacting faces of the cylinder head or the cylinder block and the other loop-like shape gasket member is designed to face the other contacting face, thereby obtaining sealing ability in which the stress distribution at the time of compressive fastening is low and stable.

Further, although it is not shown in the figure, if a coating layer made of rubber or synthetic resin is formed on at least one face of the loop-like shape gasket base plate 3, its function and effect are the same as those described in the embodiment 1. Still further, like the above-mentioned embodiment, the thickness of the loop-like shape gasket member 3a and that of the member 3b are differed and the thickness of the coating layer can be varied accordingly on the difference.

1. A gasket interposed between facing surfaces of two members to be sealed for sealing a space between said surfaces, said gasket comprising:
a loop-like shape jointed gasket base plate formed by being jointed an inner periphery of one loop-like shape gasket member to an outer periphery of the other loop-like shape gasket member, said two loop-like shape gasket members having different spring constant respectively; and
a bead portion formed along a circumferential direction of said loop-like shape jointed gasket base plate; wherein
said one of loop-like shape gasket members faces one surface of said two members and the other loop-like shape gasket member faces the other surface of said two members by said bead portion, when said gasket is disposed between said facing surfaces of said two members.

2. The gasket as set forth in claim 1, wherein said two loop-like shape gasket members are made of metal plate.

3. The gasket as set forth in claim 1, wherein said two loop-like shape gasket members are made of different material having different spring constant respectively.

4. The gasket as set forth in claim 1, wherein said two loop-like shape gaskets members have different spring constant because of their thickness.

5. The gasket as set forth in claim 1, wherein said bead portion is a half bead structure.

6. The gasket as set forth in claim 5, wherein
said bead portion has a joint portion formed by being jointed said inner periphery of said one loop-like shape gasket member and said outer periphery of said other loop-like shape gasket member, said two loop-like shape gasket members having different spring constant respectively, and
said joint portion is formed at a position deviated from an intermediate portion of its width in its radial direction.

7. The gasket as set forth in claim 1, wherein said bead portion is a full bead structure.

8. The gasket as set forth in claim 7, wherein said bead portion has a plurality of joint portions formed by being jointed said inner periphery of said one loop-like shape gasket member and said outer periphery of said other loop-like shape gasket member.

9. The gasket as set forth in claim 1, wherein said loop-like shape jointed gasket base plate is covered with a coating layer made of rubber or synthetic resin on at least its one surface.

10. The gasket as set forth in claim 1, wherein said loop-like shape jointed gasket base plate is composed of two gasket members with different spring constant respectively in which each of said two gasket members is formed itself into a loop-like shape by being punched out from a plate material so as to conform said inner periphery of said one loop-like shape gasket member to said outer periphery of said the other loop-like shape gasket member in their size, and combined with each other by being jointed said inner periphery of said one loop-like shape gasket member to said outer periphery of said the other loop-like shape gasket member, and wherein
said bead portion is formed by being fabricated said loop-like shape jointed gasket base plate.

11. The gasket as set forth in claim 2, wherein said two loop-like shape gasket members are made of different material having different spring constant respectively.

12. The gasket as set forth in claim 2, wherein said two loop-like shape gaskets members have different spring constant because of their thickness.

13. The gasket as set forth in claim 2, wherein said bead portion is a half bead structure.

14. The gasket as set forth in claim 13, wherein said bead portion has a joint portion formed by being jointed said inner periphery of said one loop-like shape gasket member and said outer periphery of said other loop-like shape gasket member, said two loop-like shape gasket members having different spring constant respectively, and
said joint portion is formed at a position deviated from an intermediate portion of its width in its radial direction.

15. The gasket as set forth in claim 2, wherein said bead portion is a full bead structure.

16. The gasket as set forth in claim 15, wherein said bead portion has a plurality of joint portions formed by being jointed said inner periphery of said one loop-like shape gasket member and said outer periphery of said other loop-like shape gasket member.

17. The gasket as set forth in claim 2, wherein said loop-like shape jointed gasket base plate is covered with a coating layer made of rubber or synthetic resin on at least its one surface.

18. The gasket as set forth in claim 2, wherein said loop-like shape jointed gasket base plate is composed of two gasket members with different spring constant respectively in which each of said two gasket members is formed itself into a loop-like shape by being punched out from a plate material so as to conform said inner periphery of said one loop-like shape gasket member to said outer periphery of said the other loop-like shape gasket member in their size, and combined with each other by being jointed said inner periphery of said one loop-like shape gasket member to said outer periphery of said the other loop-like shape gasket member, and wherein
said bead portion is formed by being fabricated said loop-like shape jointed gasket base plate.
